(19) United States
(12) Patent Application Publication
(10) Pub. No.: US 2021/0248288 A1
(43) Pub. Date: Aug. 12, 2021

(54) SIMULATION DEVICE, SIMULATION METHOD, AND ECU DEVICE

(71) Applicant: Hitachi Automotive Systems, Ltd., Hitachinaka-shi, Ibaraki (JP)

(72) Inventors: Yasunori MURASHIMA, Hitachinaka-shi, Ibaraki (JP); Yuji FUKUSHIMA, Hitachinaka-shi, Ibaraki (JP); Fumio NARISAWA, Hitachinaka-shi, Ibaraki (JP)

(73) Assignee: Hitachi Automotive Systems, Ltd., Hitachinaka-shi, Ibaraki (JP)

(21) Appl. No.: 16/973,315

(22) PCT Filed: Jun. 26, 2019
(86) PCT No.: PCT/JP2019/025303

§ 371 Date: Dec. 8, 2020

(30) Foreign Application Priority Data
Jul. 19, 2018 (JP) 2018-135829

(51) Int. Cl. G06F 30/20

(52) U.S. Cl. CPC G06F 30/20; G06F 2119/12

(57) ABSTRACT

An object of the present invention is to provide a simulation device that can adjust an execution timing in a PC simulation environment to be closer to an execution timing in an actual ECU by using a simple method, a simulation method, and an ECU device. A simulation device includes: a first computer including a first performance measurement function that obtains a first processing timing when the first computer executes application software, and a timing adjustment function that performs timing adjustment of an execution time of the application software in the first computer based on a time difference between the first processing timing and a second processing timing when a second computer executes the application software.

### TECHNICAL FIELD

The present invention relates to a simulation device having a function of adjusting an execution timing, a simulation method, and an ECU device, for example, a simulation device used by a developer during development of software of an electronic control unit (ECU) of an automobile, a simulation method, and an ECU device.

### BACKGROUND ART

In the development of software for ECUs, there are few cases where a hardware prototype is prepared at an early stage of the development. Therefore, in general, after designing software on a personal computer (PC), operation checking is performed in a PC environment (simulation environment), the software verified in the PC environment is ported to an actual ECU environment that is a hardware prototype, and then operation checking is performed.

Further, even after a hardware prototype is prepared, the number of hardware prototypes assigned to a software developer is often small. For example, one hardware prototype may be shared by ten software developers.

In such a case, operation checking of software (SW) or the like is performed in both the actual ECU environment that is a hardware prototype, and the PC environment.

In such a development flow, due to a difference in hardware (HW) performance between the PC and the ECU, an operation result of application software often differs between the PC environment and the actual ECU environment.

Due to a difference in execution timing of the application software between the PC environment and the actual ECU environment, malfunction that occurs only in one of the environments occurs.

In addition to the difference between the PC environment and the actual ECU environment, the specification of the PC used in development often differs between developers, which causes a situation that occurs only in an actual ECU and a specific PC.

In order to improve the quality of software in the upstream process of software development where a PC simulator is used, it is important to adjust a processing timing in the PC simulation environment to be closer to an actual ECU processing timing for each PC used.

In this regard, claim 2 of PTL 1 states that “a clock interrupt simulation in which only a time for which a simulation development environment actually uses a microprocessor unit of a development machine is measured can be executed”.

### CITATION LIST

### Patent Literature

PTL 1: JP H05-282160 A

### SUMMARY OF INVENTION

### Technical Problem

In PTL 1, a processing start timing by the clock interrupt can be adjusted, but subsequent processing timings cannot be adjusted. Therefore, a difference due to the HW performance occurs.

For example, when operating multiple applications on a multitasking operating system, an update timing of a variable shared between tasks may differ between the simulation environment and the actual ECU environment. As a result, a timing of referring to the variable may change, which may cause a difference in operation of the application software.

Even in a case where a mechanism for timing adjustment is provided in order to improve the reproducibility in the PC simulator, since there is a difference in performance (clock frequency or the like) between PCs used by developers, a parameter for the timing adjustment needs to be individually adjusted for each PC.

Therefore, a CPU clock ratio is used as information for determining the parameter for the timing adjustment, but it is difficult to calculate an effective parameter only with a fixed formula due to a factor such as a difference in external memory access performance or an influence of another process running on the PC.

Therefore, an object of the present invention is to provide a simulation device that can adjust an execution timing in a PC simulation environment to be closer to an execution timing in an actual ECU by using a simple method, a simulation method, and an ECU device.

### Solution to Problem

In view of the above, according to the present invention, “a simulation device includes: a first computer including a first performance measurement function that obtains a first processing timing when the first computer executes application software, and a timing adjustment function that performs timing adjustment of an execution time of the application software in the first computer based on a time difference between the first processing timing and a second processing timing when a second computer executes the application software”.

According to the present invention, “a simulation device includes: a first computer including a first performance measurement function that obtains a first processing timing when the first computer executes an application software, and a timing adjustment function that performs timing adjustment of an execution time of the application software in the first computer based on a time difference between the first processing timing and a second processing timing when a second computer executes the application software; the second computer including a second performance measurement function that obtains, as the second processing timing, a processing timing when the application software is executed; and a communication device via which the first computer and the second computer are connected to each other”.

According to a preset invention, “an ECU device includes: a performance measurement function for obtaining a second processing timing when application software is executed; a measurement result storing unit that stores the second processing timing; and a communication device for transmitting the second processing timing to the outside”.

According to the present invention, “a simulation method includes: performing timing adjustment of an execution time of application software in a first computer based on a time difference between a first processing timing when the first computer executes the application software and a second processing timing when a second computer executes the application software”.

### Advantageous Effects of Invention

According to the present invention, the execution timing in the PC simulation environment can be adjusted to be closer to the execution timing in the actual ECU. Since the timing adjustment can be performed for each PC, the delay amount can be adjusted for each PC environment of a developer.

Further, according to the embodiments of the present invention, software can be verified in an environment in which a processing timing that is close to a processing timing in an actual ECU is realized even when the number of actual ECU prototypes during development is small, and thus it is possible to assist in ensuring the quality of software in the upstream process.

### BRIEF DESCRIPTION OF DRAWINGS

FIG. 1 is a diagram illustrating an example of configurations of an actual electronic control unit (ECU) environment and a personal computer (PC) environment in a simulation device of the present invention.

FIG. 2 is a diagram illustrating a hardware configuration and main processing functions of a PC that implements the simulation device, the hardware configuration and main processing functions being particularly related to a delay injection function Sw11.

FIG. 3 is a diagram illustrating a generation process in which software to be ported to an ECU device is created by using the simulation device.

FIG. 4 is a diagram illustrating processing related to a first stage of application development according to Embodiment 2 of the present invention.

FIG. 5 is a diagram illustrating an example of a C language program used in the present invention.

FIG. 6 is a diagram illustrating a table setting example of a delay parameter file Fi3.

FIG. 7 is a diagram illustrating an example of an execution timing in the actual ECU, and execution timings in a simulator when timing adjustment is not performed and when the timing adjustment is performed.

FIG. 8 is a diagram illustrating an example of a timing in a case where a processing speed of the ECU is higher than a processing speed of the PC.

FIG. 9 is a diagram illustrating a ratio of the number of CPU clocks of the actual ECU to the number of clocks of the PC on which the simulator is operated.

FIG. 10 is a diagram illustrating a processing timing in a case of execution in the actual ECU and a processing timing in a case of execution in the PC simulator.

FIG. 11 is a diagram illustrating task priorities of tasks A and B.

FIG. 12 is a diagram illustrating the concept of timing adjustment in a case of interrupt processing in multitasking.

FIG. 13 is a diagram illustrating a processing flow of a delay amount determination and adjustment function of the PC that implements the simulation device, and an actual environment machine S.

FIG. 14 is a diagram illustrating the concept of the delay amount determination and adjustment function.

FIG. 15 is a diagram illustrating an example of a C language program used in the present invention.

FIG. 16 is a schematic flowchart illustrating contents of processing in the PC and processing in the actual environment machine S, which are executed for delay amount determination and timing adjustment.

FIG. 17 is a diagram illustrating an example of configurations of an ECU measurement result file Fi1 and a PC measurement result file Fi2.

FIG. 18 is a diagram illustrating a time relationship before and after timing adjustment.

FIG. 19 is a diagram illustrating a specific processing flow of the update of the delay parameter file Fi3.

FIG. 20 is a diagram illustrating an example of a delay parameter table in an initial state before performance comparison.

FIG. 21 is a diagram illustrating a delay parameter table in which a delay amount for each child function is reflected in the delay parameter table in the initial state of FIG. 20.

FIG. 22 is a diagram illustrating an example of execution timings when context switching in multitasking occurs.

FIG. 23 is a diagram illustrating an example of a start time and an end time stored in each task.

### DESCRIPTION OF EMBODIMENTS

Hereinafter, a simulation device according to the present invention will be described in detail with reference to the drawings. Note that embodiments of the present invention are diversified. Embodiment 1 mainly and particularly describes a hardware configuration of the simulation device, Embodiments 2 to 5 describe that delay processing for adjusting an execution timing in a personal computer (PC) simulation environment to be closer to an execution timing in an actual electronic control unit (ECU) is executed, and Embodiment 6 and subsequent embodiments describe that a delay amount for adjusting the execution timing in the PC simulation environment to be close to the execution timing in the actual ECU is determined for each PC, and timing adjustment is performed while executing delay processing at a predetermined position at the time of execution in the PC simulation environment.

### Embodiment 1

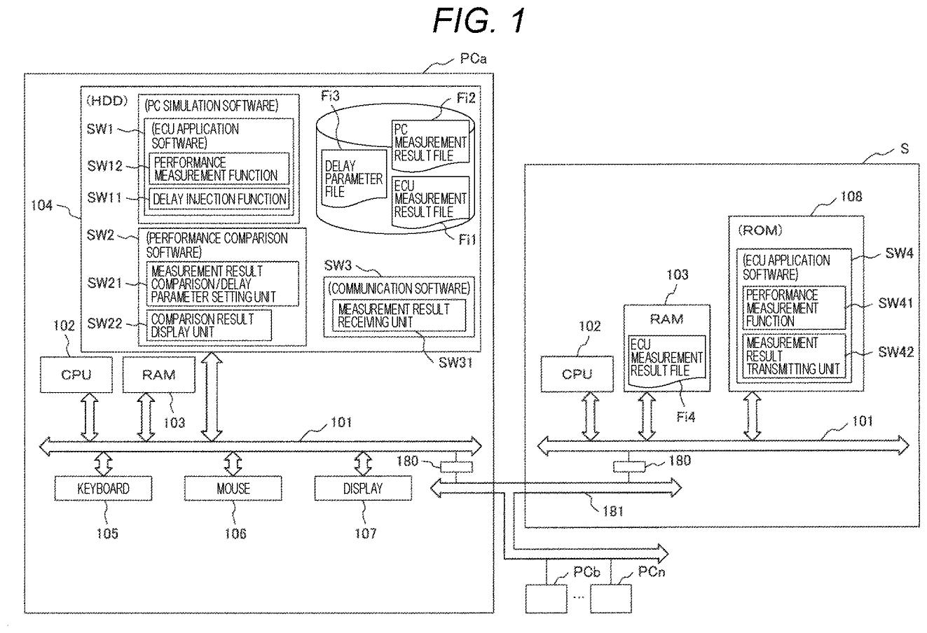

In Embodiment 1, particularly, the hardware configuration of the simulation device will be mainly described. FIG. 1 is a diagram illustrating an example of configurations of the actual ECU environment and the PC environment in the simulation device of the present invention.

The right side of FIG. 1 illustrates an example of a configuration of an actual environment machine S that realizes the actual ECU environment, and the left side of FIG. 1 illustrates an example of a configuration of the PC that realizes the PC environment. The actual environment machine S and a plurality of PCs (PCa, PCb, . . . , and PCn) are connected to an external system bus 181 via a communication device 180. Since the PC basically has the same configuration and function, the PC PCa will be described below as a representative example.

Since the actual environment machine S and the PC are both implemented by a computer system, in hardware configurations thereof, as well known, a central processing unit (CPU) 102, a main storage device (random access memory (RAM)) 103, a hard disk drive (HDD) 104 or a read only memory (ROM) 108, and the like are connected to a system bus 101. Further, a keyboard 105, a mouse 106, and a display 107 for a developer to perform a simulation operation or verification of a simulation result are connected to the PC.

The hardware configurations of the actual environment machine S and the PC are as described above, and the hard disk drive 104 or the ROM 108 is equipped with main functions realized here.

First, the hard disk drive 104 of the PC that realizes the PC environment stores, as software Sw operated in the PC simulation environment, ECU application software Sw1, performance comparison software Sw2, and communication software Sw3 that performs communication with the ECU. Note that the ECU application software Sw1 includes a delay injection function Sw11 and a performance measurement function Sw12, the performance comparison software Sw2 includes a measurement result comparison/delay parameter setting unit Sw21 and a comparison result display unit Sw22, and the communication software Sw3 includes a measurement result receiving unit Sw31. Note that the ECU application software Sw1 represents simulation software (PC simulation software) on the PC.

In addition, the hard disk drive 104 of the PC that realizes the PC environment stores, as data files Fi for various data used at the time of operation in the PC simulation environment, an ECU measurement result file Fi1 in which an ECU measurement result is stored, a PC measurement result file Fi2 in which a PC measurement result is stored, and a delay parameter file Fi3 in which a delay parameter determined by comparing the contents of both measurement results is stored.

On the other hand, the ROM 108 of the actual environment machine S that realizes the actual ECU environment stores ECU application software Sw4. The ECU application software Sw4 includes a performance measurement function Sw41 and a measurement result transmitting unit Sw42. The main storage device (RAM) 103 of the actual environment machine S that realizes the actual ECU environment stores, as a data file Fi for various data used at the time of operation in the actual ECU environment, an ECU measurement result file Fi4 in which an ECU measurement result is stored.

It should be understood that the configuration and processing described in FIG. 1 are described as an embodiment, and there is no intention to limit the technical scope of the present invention to this embodiment.

Among various processing described with reference to FIG. 1, the delay injection function Sw11 in the ECU application software Sw1 in the hard disk drive 104 of the PC is to execute delay processing for adjusting the execution timing in the PC simulation environment to be closer to the execution timing in the actual ECU, which will be described in Embodiments 2 to 5. In addition, other processing functions in FIG. 1 are to determine, for each PC, a delay amount for adjusting the execution timing in the PC simulation environment to be closer to the execution timing in the actual ECU, and to perform timing adjustment while executing the delay processing at a predetermined position at the time of execution in the PC simulation environment, which will be described in Embodiment 6 and subsequent embodiments.

### Embodiment 2

In the description of Embodiments 2 to 5 of the present invention, the hardware configuration and main processing functions of the PC that implements the simulation device, the hardware configuration and main processing functions being particularly related to the delay injection function Sw11, will be described. In addition, a generation process in which software to be ported to the ECU device is created by using the simulation device will be described.

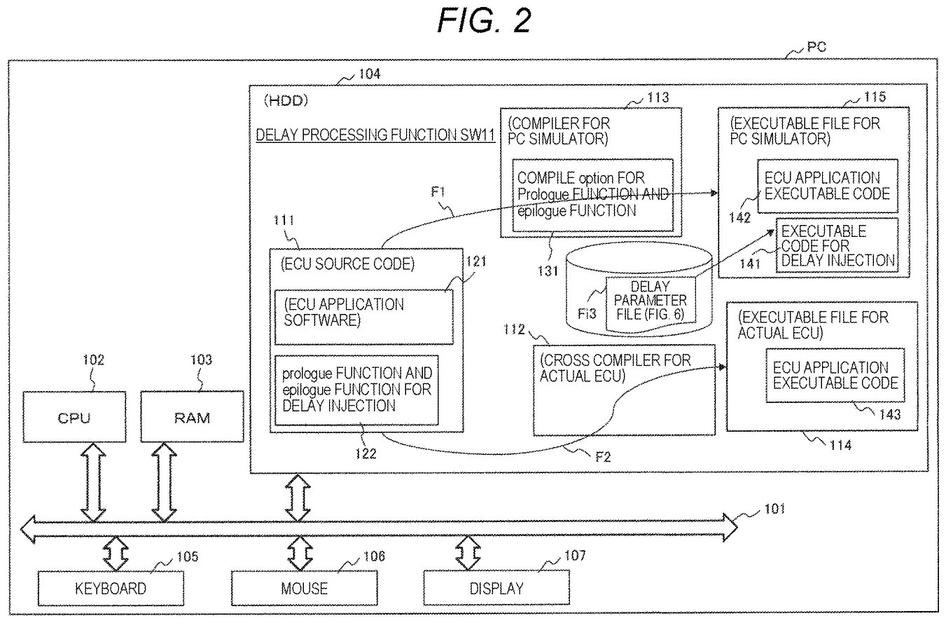

First, the hardware configuration and main processing functions of the PC that implements the simulation device will be described with reference to FIG. 2, the hardware configuration and main processing functions being particularly related to the delay injection function Sw11.

As described in FIG. 1, the simulation device of FIG. is implemented by a general PC, and in the hardware configuration thereof, the CPU 102, the main storage device (RAM) 103, the hard disk drive (HDD) 104, the keyboard 105, the mouse 106, the display 107, and the like are connected to the system bus 101 of the PC.

In the simulation device of FIG. 2, the delay injection function Sw11 of FIG. 1 is specifically deployed, which can be represented as various functions or products formed in the hard disk drive 104. Specifically, the delay injection function Sw11 can be expressed as that an ECU source code 111 for the ECU application software, a cross compiler 112 for generating an execution file for the actual ECU, a compiler 113 for generating an execution file for PC simulation, an execution file 114 for the actual ECU that is generated by building the application software 111 using the cross compiler 112, and an execution file 115 for the PC simulator that is generated by building the application software 111 using the compiler 113 can be held or formed in the delay injection function Sw11.

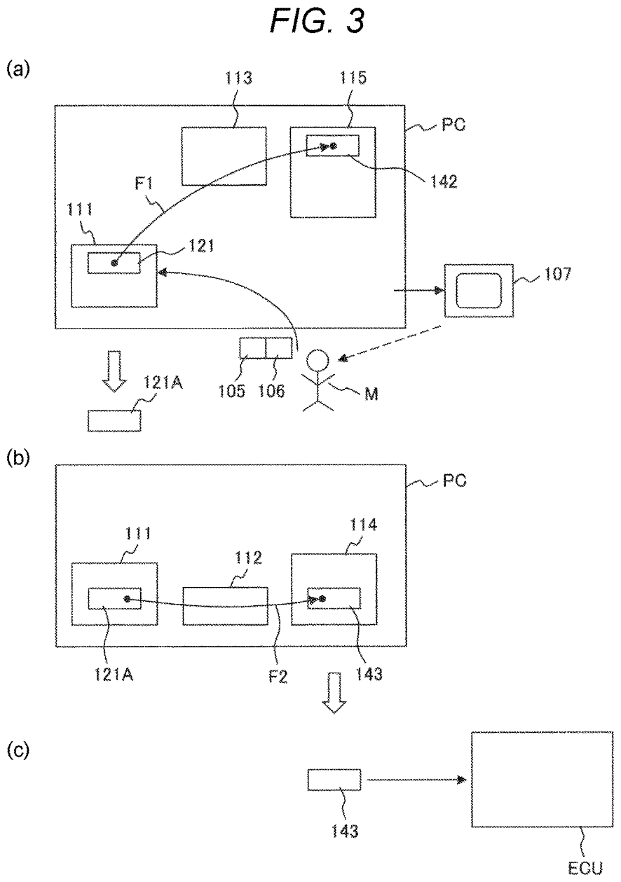

Referring to FIG. 2, there are a processing flow F1 for forming the execution file 115 for the PC simulator from a source code 111 of the ECU application software, and a processing flow F2 for forming the execution file 114 for the actual ECU from a source code 111 of the ECU application software. These processing flows F1 and F2 are executed by a procedure illustrated in FIG. 3 and described later.

Note that the ECU source code 111 includes ECU application software 121 that is operated in both the actual ECU and the PC simulator, and functions 122 for delay injection that are operated only in the PC simulator environment.

Further, the hard disk drive 104 of the PC stores the delay parameter file Fi3 that stores delay information used only in the PC simulator environment.

The compiler 113 for the PC simulator includes a compiling option 131 for hooking, into ECU software, processing of calling the functions for delay injection. When the ECU source code 111 is compiled by the compiler 113 with the compiling option 131 specified, the execution code 141 for delay injection is included in the execution file 115 for the PC simulator. The execution code 141 for delay injection has a function of executing delay processing for a delay amount described in the delay parameter file Fi3.

Note that the ECU application execution code 142 and the execution code 141 for delay injection are generated and stored in the execution file 115 for the PC simulator by the compiling processing in the processing flow F1, and an ECU application execution code 143 is generated and stored in the execution file 114 for the actual ECU by compiling processing in the processing flow F2.

It should be understood that the configuration and processing described here are described as an embodiment, and there is no intention to limit the technical scope of the present invention to this embodiment.

FIG. 3 is a diagram illustrating a conventional generation process in which software to be ported to the ECU is created by using the simulation device.

(a) of FIG. 3 illustrates a first stage of application development, in which, for example, the ECU application software 121 for brake operation in the ECU is converted by the compiler 113 for the PC simulator, and the ECU application execution code 142 is generated in the execution file 115 for the PC simulator.

The flow of this processing is shown as the processing flow F1.

Further, at this stage, various simulations using the ECU application execution code 142 are executed in the PC, and results thereof are appropriately displayed on the display 107 or the like. A developer M receives the simulation results displayed on the display 107 and appropriately modifies the ECU application software 121 by using an input means such as the mouse 106 or the keyboard 105, thereby finally obtaining application software 121A. Finally, ECU application execution file code 142A (not illustrated) is obtained.

(b) of FIG. 3 illustrates a second stage of the application development, in which the ECU application software 121A finally generated at the first stage of the application development is converted by the cross compiler 112 for the actual ECU, and the ECU application execution code 143 is generated in the execution file 114 for the actual ECU. The flow of this processing is shown as the processing flow F2.

(c) of FIG. 3 illustrates an ECU checking stage, in which the ECU application execution code 143 finally obtained at the second stage of the application development is ported to the ECU, and various examinations or the like are performed by an actual machine.

The above-described procedure illustrated in FIG. 3 shows the conventional generation process in which software to be ported to the ECU is created by using the simulation device, but the problem in this case is that a difference in HW performance (hardware performance difference) between a first computer that implements the simulation device and a second computer that implements the ECU causes a difference in application software operation result between the PC environment and the ECU environment.

Note that, as the difference in HW performance between the first computer and the second computer, a difference in clock frequency will be described as an example in the following example. Note that, in Embodiment 2, a case where a clock frequency fe of the ECU is 1000 Hz, a clock frequency fp of the PC is 3000 Hz, and the PC has a higher performance than the ECU is described as an example. In Embodiment 3, a case where the ECU has a higher performance than the PC is described.

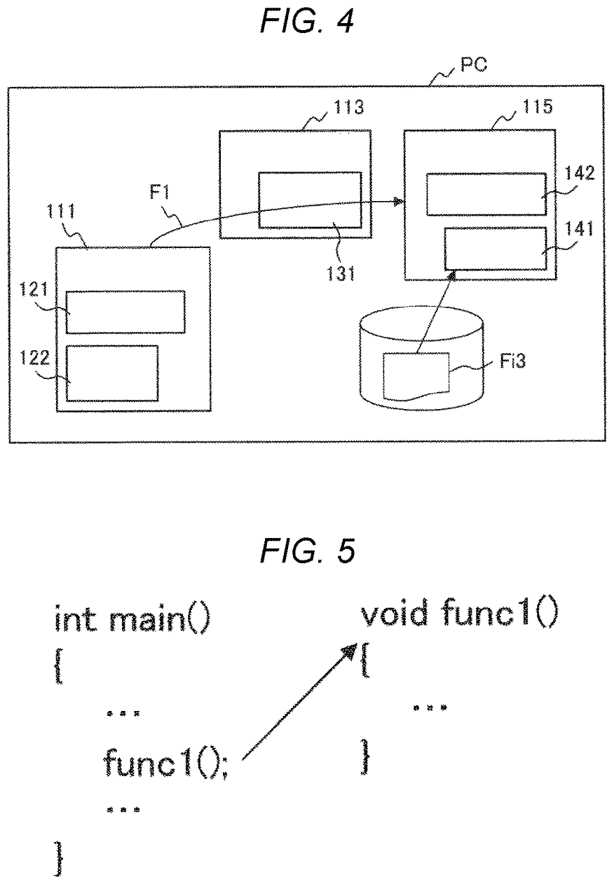

Embodiment 2 of the present invention is an improvement of the processing related to the first stage of the application development in (a) of FIG. 3. FIG. 4 illustrates processing related to a first stage of application development according to Embodiment 2 of the present invention.

In the first stage of the application development in FIG. 4, the following functions or processing are added to the first stage of the application development in (a) of FIG. 3. The added functions include the functions 122 for delay injection added to the ECU source code 111, the delay parameter file Fi3 created on the PC, the function compiling option 131 added to the compiler 113 for the PC simulator, and the execution code 141 for delay injection added to the execution file 115 for the PC simulator.

With the configuration of FIG. 4, execution timing adjustment processing can be attached or detached depending on whether or not the compiling option is specified.

In short, these added functions are to “set a predetermined delay time for a predetermined timing” in a program (the ECU application execution code 142 generated in the execution file 115 for the PC simulator) that is finally formed. Therefore, it is preferable to adopt a C language, a C++ language, or JAVA (registered trademark) as a programming language in the computer of the present invention. In addition, these languages will be simply referred to as the C language hereinafter.

FIG. 5 is a diagram illustrating an example of a C language program used in the present invention. The C language program is a simple program that calls a func1 function in a Main function as illustrated in FIG. 5 and executes the rest of the Main function after the func1 function ends. Note that, in the Main function, a plurality of func functions can be called to execute processing. Note that the Main function may be called a parent function and the func function may be called a child function.

The functions 122 for delay injection added to the ECU source code 111 of FIG. 2 are a prologue function that is a function for performing a function of “setting a predetermined delay time for a predetermined timing” and is used to set a delay time at the beginning of the program, and an epilogue function used to set a delay time at the end of the program, among func functions of the C language.

Note that the ECU is a so-called control computer used by being incorporated in a vehicle. Therefore, for example, a single-tasking ECU is activated in a period of 10 (ms), and each time the ECU is activated, a series of processing described in the Main function are operated so as to sufficiently complete the processing within this period. Therefore, the PC, which is the simulation device, is configured and operated on the assumption that it is also treated as a control computer. Note that a multitasking ECU has a control period of a different system, for example, the ECU is activated in a period of 5 (ms), and is operated according to an appropriate priority.

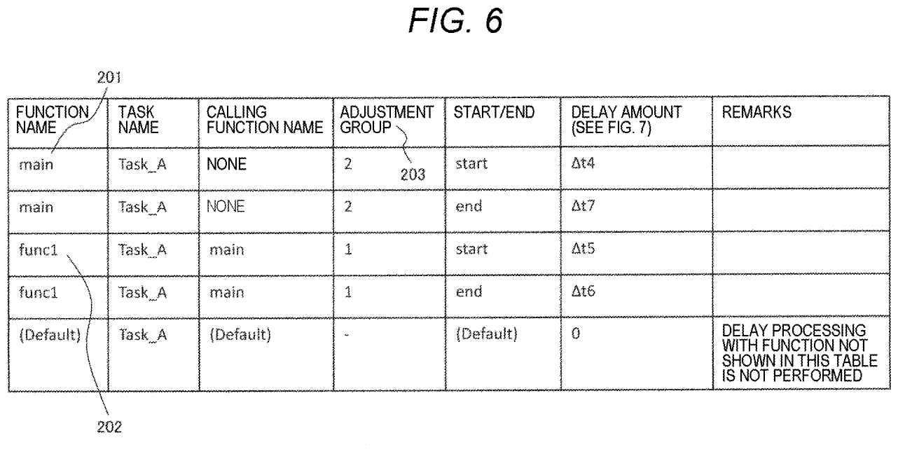

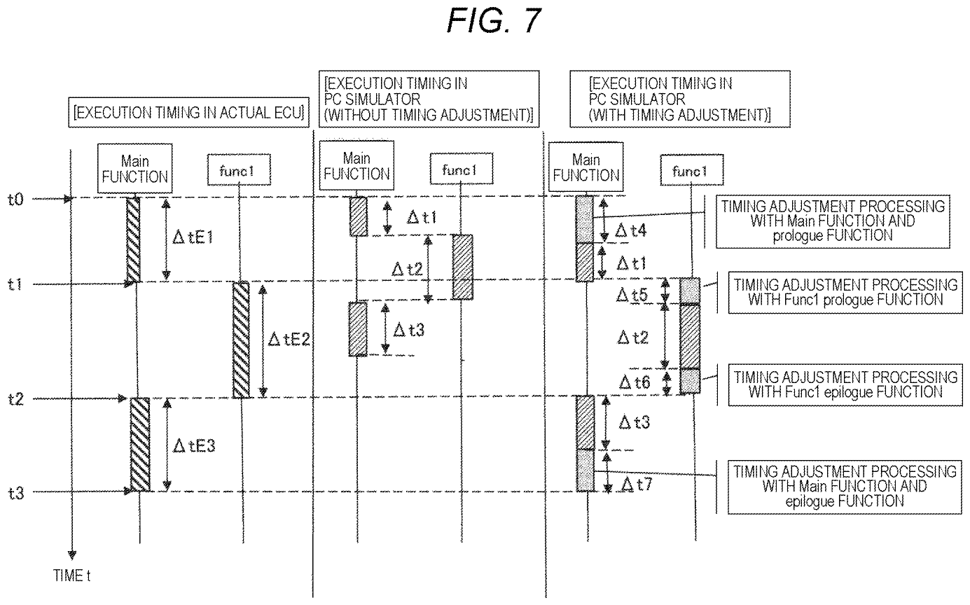

FIG. 6 illustrates a table setting example of the delay parameter file Fi3 defined in FIG. 2 according to the present embodiment. Here, for the Main function, the func1 function, and Default, conditions such as a delay time setting position, a calling function name, a delay amount, and a remark are described. The table in FIG. 6 shows a state after the setting of the delay amount is completed. Delay amounts At4 to At7 set in this table are illustrated in a timing example of FIG. 7.

For example, in a row 201 for the Main function, At4 is set as a delay amount to be applied in a Prologue function (hereinafter, processing by this function is referred to as prologue processing) of the Main function.

In a row 202 for the func1 function, At7 is set as a delay amount in an epilogue function (hereinafter, processing by this function is referred to as epilogue processing) of the func1 function. Note that Default means that standard settings are made for parts that are not defined by the Main function or func function. In this example, a delay amount to be applied is 0 (no delay processing is executed) in the prologue processing and the epilogue processing of a function that is not described.

An adjustment group 203 illustrated in FIG. 6 will be described later in Embodiment 7.

FIG. 7 illustrates an example of an execution timing in the actual ECU, an execution timing in the PC simulator when timing adjustment is not performed, and an execution timing in the PC simulator when the timing adjustment is performed.

First, the execution timing in the ECU on the left side of FIG. 7 will be described. As described above, in this timing processing, the execution timing is a timing in a case where the ECU has a control period of 10 (ms) and a clock frequency of 1000 Hz.

Here, it is assumed that the control period of 10 (ms) is started at a time to.

In this example, the program requires a time of AtE1 for processing of a front part of the Main function, requires a time of AtE2 for processing of the func1 function, and requires a time of AtE3 for a rear part of the Main function, and the total time is within the control period of the ECU of 10 (ms) such that the processing are sufficiently completed. Note that a time at which the processing of the front part of the Main function is completed is represented by t1, a time at which the processing of the func1 is completed function is represented by t2, and a time at which the processing of the rear part of the Main function is completed is represented by t3.

On the other hand, it is desirable that the same timing as the execution timing in the ECU can be realized inside the simulation device using the PC.

In this regard, according to the conventional method (the center of FIG. 7) in which the time adjustment is not performed as illustrated in FIG. 3, an execution start time is a time t0 in both the actual ECU and the PC simulation environment, but a clock frequency of the PC is 3000 Hz, and thus a series of processing are completed in a short time. Specifically, the processing of the front part of the Main function requires a time of At1, the processing of the func1 function requires a time of At2, and the processing of the rear part of the Main function requires a time of At3, but these times are sufficiently shorter than the respective times in the actual ECU, and thus the execution timing is completely different from that in the actual ECU. In the present invention, the delay amount of the delay parameter file Fi3 described in FIG. 6 is calculated and set based on the difference in execution time between the actual ECU and the PC simulation environment. The calculation of the delay amount will be described in Embodiment 6 and subsequent embodiments.

In the present invention, by appropriately setting a delay time at a front part and a rear part of a function, it is possible to realize a timing close to the execution timing in the ECU on the left side of FIG. 7. Note that in a case where the timing adjustment is performed on the right side of FIG. 7, a start time of the control period is to, as in the other cases.

At this time, the program starts from the Main function. First, referring to the delay parameter file Fi3 in FIG. 6, the prologue processing of the Main function of the row 201 is executed. Since a delay amount in the prologue processing of the Main function is At4, the processing of the func1 function is executed after the delay time At4 elapses. When the main function is executed, the func1 function is called after the time of At1. In a case where the delay amount in the prologue processing of the Main function is appropriate, a timing at which the func1 function is called is adjusted to be closer to that in the actual ECU.

Next, the program refers to the delay parameter file Fi3 in FIG. 6 and executes prologue processing of the func1 function of a row 203. Here, At5 is set as the delay amount, and thus the processing of the func1 function is executed after the delay time of At5 elapses.

A time for which the func1 function is executed is At2, which is the same as a case where the timing adjustment is not performed. By the setting in the delay parameter file Fi3 in FIG. 6, a delay amount of At6 is set for epilogue adjustment processing of the func1 function, and delay processing for At6 is executed, such that it is possible to adjust a start time of the processing of the rear part of the main function to match a start time t2 of the processing of the main function in the ECU.

Similarly, by the setting in the delay parameter file Fi3 in FIG. 6, a delay amount of At7 and a coefficient of 3 are set for epilogue adjustment processing of the main function, and delay processing for At7 is executed, such that it is possible to adjust an end time of the processing of the rear part of the main function to match an end time t3 of the processing of the rear part of the main function in the ECU.

In setting the delay time in each function, whether to set a time from an absolute time (for example, a start time of the control period) or to set a time from an occurrence time of a previous event (for example, a start time and an end time of each function) can be appropriately selected.

As described above, according to the present invention, a processing timing in the PC simulation environment can be adjusted to be closer to a processing timing in the actual ECU by implementing a mechanism capable of implementing and adding the delay processing operated only in the PC simulation environment.

A position where the delay processing is applied is “prologue processing called at the start of the function” or “epilogue processing called at the end of the function”. It is possible to implement the delay processing at any one of those or both of those.

Furthermore, processing of calling a delay injection function can be implemented by adding a compiling option. It is preferable to use a function to specify a function operated in prologue and epilogue, such as a “-finstrument-functions” option of a GNU compiler collection (GCC). It is not necessary to add processing of calling a test code in application software for the test in the PC simulation environment.

As described above, the present invention is a simulation device for converting application software into an execution code, verifying the execution code, and porting the verified execution code to another computer device, in which time adjustment processing is executed with a function of a source code of an application as a unit at the start or end of the function to adjust an execution timing in another computer device.

### Embodiment 3

In Embodiment 2, the delay time is set at the front part or rear part of each function to perform timing matching with the ECU on the assumption that a processing speed of the ECU is lower than a processing speed of the PC. That is, the delay processing is performed as the time adjustment processing.

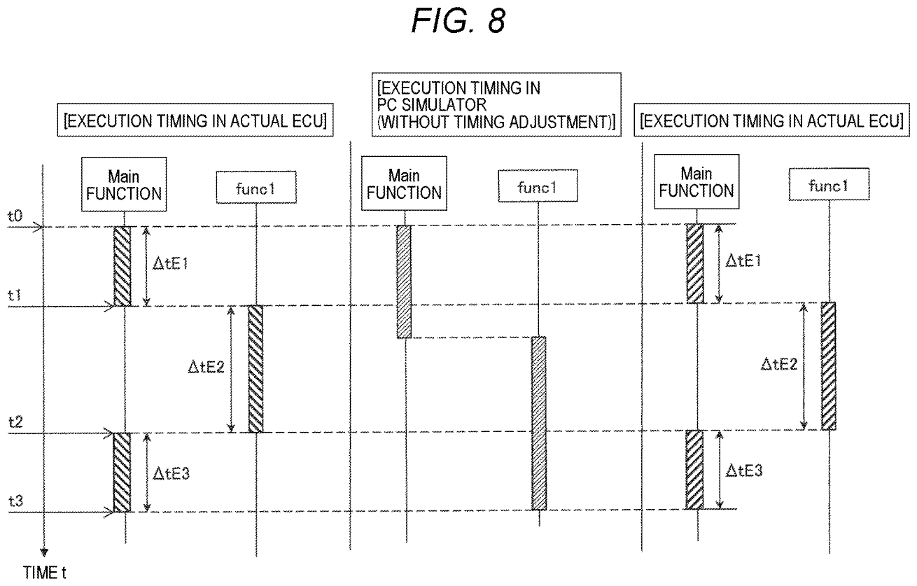

On the other hand, the processing speed of the ECU may be higher than the processing speed of the PC. FIG. 8 is a diagram illustrating an example of a timing in a case where the processing speed of the ECU is higher than the processing speed of the PC. FIG. 8 illustrates a countermeasure for such a case. For example, a case where the ECU requires AtE1 for processing of the Main function, and the PC requires more time is assumed. In this case, it is preferable to adjust the time required for the processing of the Main function in the PC to be the same as the processing time of AtE1 in the ECU by multiplying the time required for the processing of the Main function in the PC by an appropriate coefficient. Here, time reduction processing is executed as the time adjustment processing.

### Embodiment 4

Embodiment 4 also assumes a countermeasure when the processing speed of the ECU is higher than the processing speed of the PC.

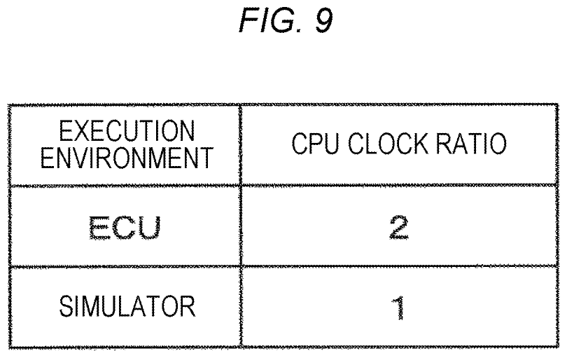

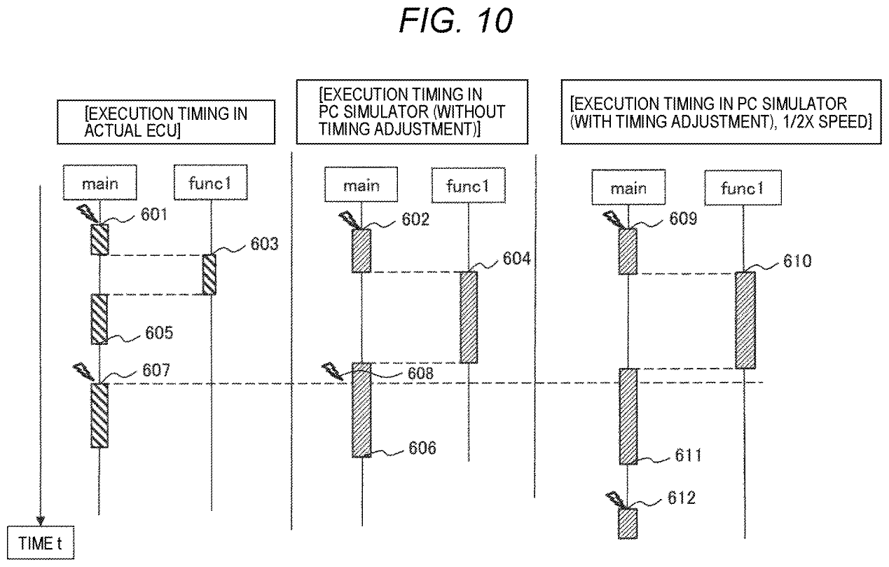

In Embodiment 4, an example of a case of executing the simulation at a speed lower than that in the actual ECU environment will be described with reference to FIGS. 9 and 10. An embodiment in which the actual ECU and the PC on which the simulator is operated are compared, and a timing adjustment function when the speed of the actual ECU is higher than that of the PC is applied will be described.

An embodiment in which the main function illustrated in FIG. 5 is periodically executed will be described. FIG. 9 illustrates a ratio of the number of CPU clocks of the actual ECU to the number of clocks of the PC on which the simulator is operated. In this example, the actual ECU is twice as good in performance as the PC.

FIG. 10 illustrates a processing timing in a case of execution in the actual ECU and a processing timing in a case of execution in the PC simulator.

Periodic processing timer events 601 and 602 occur, and periodic processing is started by starting the main function. The func1 function is called from the Main function (603 and 604). After the Func1 function is executed, the process returns to the main function, and the periodic processing is completed when the main function ends (605 and 606). As the next periodic processing timer event is issued (607 and 608), the next periodic processing is started in the main function. However, in the present embodiment, it can be confirmed from timings of 606 and 608 in a reverse order that the previous periodic processing is not ended due to the low CPU performance in the PC simulator environment.

In the PC simulator environment, it is not possible to execute processing at the same timing as that in the ECU in a case of execution at a 1× speed. Therefore, a timer event occurrence interval in the PC simulation environment can be increased by twice by halving the speed based on the CPU ratio, such that it is possible to execute processing at the processing timing in the PC simulation environment that is close to the processing timing in the actual ECU.

The right side of FIG. 10 illustrates a processing timing when processing is executed at a ½× speed in the PC simulation environment. The occurrence of a timer event (609), the start of execution of the func1 function (610), and the end of the main function (611) are the same as the execution timings in a case of 1× speed reproduction in the PC simulation environment. However, a timing (612) at which a next periodic processing timer event occurs is delayed by twice that in a case of the normal speed reproduction, such that the periodic processing in the PC simulation environment can be completed within the period. Note that a correction method in prologue/epilogue in a case where the execution time of the function in the PC is shorter than twice the execution time in the ECU is the same as that in Embodiment 1.

A period in which the timer event occurs is changed in prologue processing or epilogue processing of a function executed in program initialization processing or the like.

As a variation of the present embodiment, it is also possible to provide a virtual time instead of the real time in the PC and correct the virtual time to a time reaching thereto in the ECU, in prologue/epilogue. In this method, since the correction of the virtual time is performed instead of inserting a waiting time, the simulation time can be reduced.

### Embodiment 5

In Embodiments 2 to 4, the embodiments in which the timing adjustment function is applied to the program in which only one task is operated on one CPU (so-called single-tasking) have been described. On the other hand, in a multitasking ECU, it is necessary to apply the timing adjustment function to a program in which a plurality of tasks A and B are operated on one CPU.

In such a multitasking method, switching processing, in which a processing request for another task with a high priority is input during execution of one task, the one task is interrupted and processing of the other task is executed, and after the processing is completed, the remaining part of the one task is executed again, is performed.

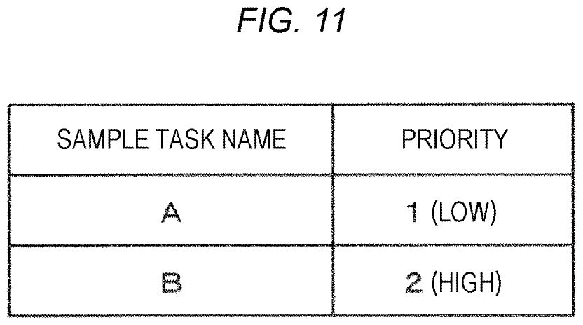

FIG. 11 illustrates task priorities of tasks A and B. A case in which the task A is activated in a control period of, for example, 10 (ms), the task B is activated in a control period of, for example, 5 (ms), and the priority of the task B is higher than that of the task A is illustrated as an example.

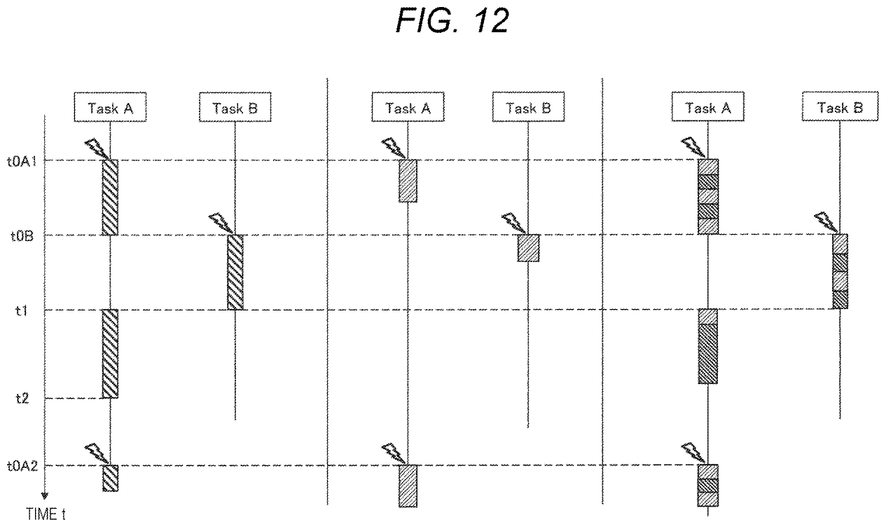

FIG. 12 illustrates the concept of timing adjustment in a case of interrupt processing in multitasking. The left side of FIG. 12 illustrates actual processing in the ECU, and the task A and the task B are executed with different control periods. Here, periodic processing timer activation times of the task A are represented by t0A1 and t0A2, and a periodic processing timer activation time of the task B is represented by t0B. Further, in this example, the control period of the task A is between the times t0A1 and t0A2, and due to interrupt processing by the task B, a resume time of the task A becomes t1 and an end time of the task A becomes t2.

In this example of FIG. 12, the task A starts processing triggered by a timer event at the time t0A1. Then, a timer event of task B was issued at the time t0B during the execution of processing of the task A. At this time, the execution of the task A is interrupted and the processing of the task B starts in accordance with the priority.

According to an event occurrence timing of this example, in the actual ECU, the execution processing of the task A does not end before the task B starts, and switching to the task B occurs. After the processing of the task B ends, the execution of the task A is resumed.

On the other hand, according to the conventional processing illustrated at the center of FIG. 12, since the processing speed in the PC simulator environment is higher than that in the ECU, the execution of the task A ends before the task B starts, and thus task switching does not occur. That is, the conventional method cannot implement the task switching in multitasking. As a result, there is often occurred a problem that even in a case where processing can be executed within one period and is correctly operated in the PC simulator environment, when operation checking is performed after porting to the actual ECU environment, the processing is not completed within one period.

The operation of the present invention in a case where timing adjustment is made in prologue and epilogue processing of a function in the PC simulation environment is illustrated on the right side of FIG. 12. According to the illustrated example, by adding an appropriate delay time, it is possible to form a front processing portion of the task A, and similarly, it is possible to form rear processing portions of the task B and the task A, thereby realizing the interrupt processing.

As such, since the timing adjustment processing is finely made with a function as a unit as in Embodiment 2, when the timer events of the task A and the task B occur at the same timing in the actual ECU and the PC simulator, the task switching occurs even in the PC simulator. That is, in a case of the multitasking method in which tasks are operated with different control period, the simulation device can perform time adjustment processing for each of a plurality of tasks and implement interrupt processing.

In the multitasking method, an execution time stored to adjust the timing may be managed for each task, and processing to stop counting up an execution time of a task whose resource is taken by the timing adjustment processing after the task switching is performed may be executed.

In this example, the execution of the task A is stopped in a prologue function at the start of periodical processing of the task B. The counting of the processing time of the task A is stopped in the prologue function at the start of the task B, and the counting-up of the execution time of the task A is resumed in an epilogue function at the end of the processing of the task B. After that, when a timing adjustment timing comes, timing adjustment is performed by calculating a timing adjustment time based on an execution time before the resource is taken by the task B and after the resource is restored.

### Embodiment 6

Embodiment 6 and subsequent embodiments describe determining, for each PC, a delay amount for adjusting the execution timing in the PC simulation environment to be closer to the execution timing in the actual ECU, and performing timing adjustment while executing the delay processing at a predetermined position at the time of execution in the PC simulation environment.

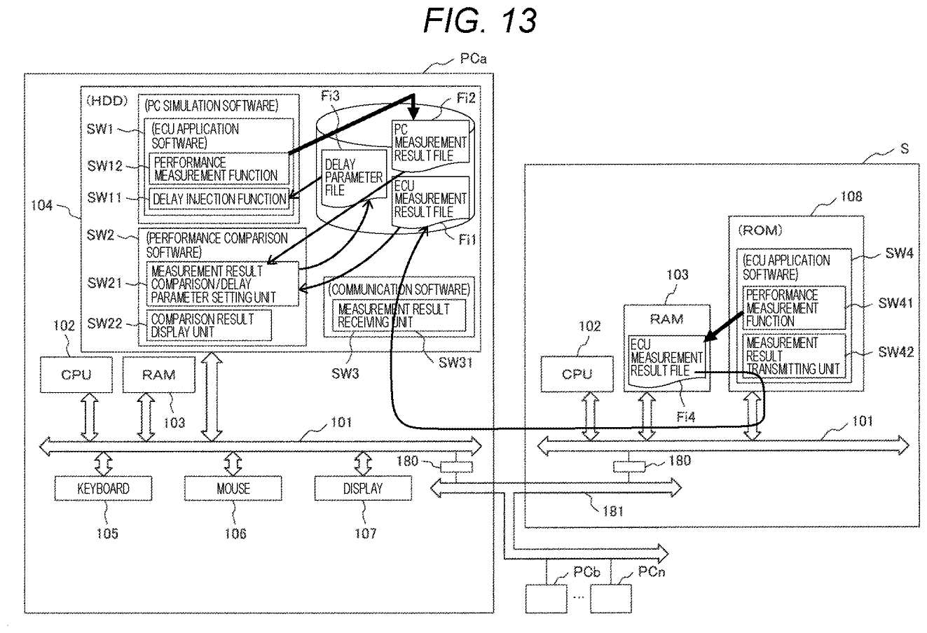

FIG. 13 is a diagram illustrating a processing flow of a delay amount determination and timing adjustment function of the PC that implements the simulation device, and the actual environment machine S.

Referring to FIG. 13, a performance test of a hardware prototype in the actual ECU environment is performed on the actual environment machine S. Here, in the ECU application software Sw4 in the ROM 108 of the actual environment machine S that realizes the actual ECU environment, the performance measurement function Sw41 is operated to obtain a measurement result in the ECU simulator in the RAM 103 and the measurement result is stored as the ECU measurement result file Fi4.

Then, as the measurement result transmitting unit Sw42 in the ECU application software Sw4 is operated, the ECU measurement result file Fi4 is stored as the ECU measurement result file Fi1 in the PC via the measurement result receiving unit Sw31 which is communication software in the PC.

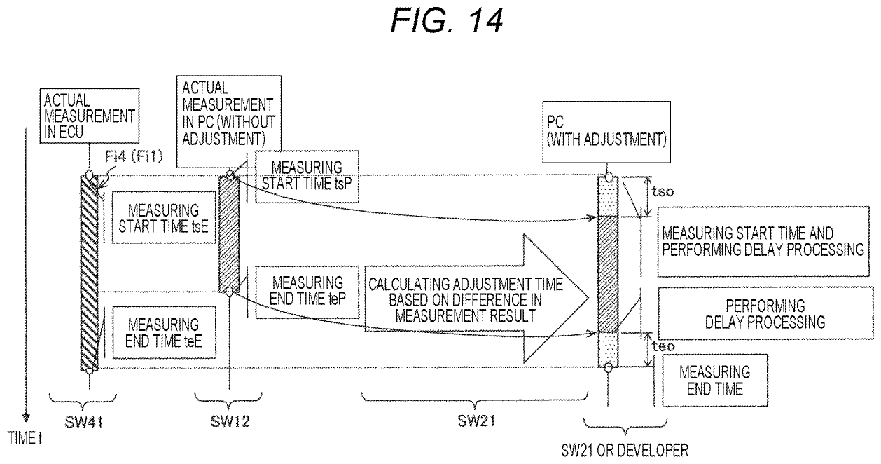

FIG. 14 is a diagram illustrating the concept of the delay amount determination and timing adjustment function. Comparing with the processing of FIG. 13, in the above-described processing in the actual environment machine S, a start time tsE and an end time teE of the application software (actual ECU) are measured as results (ECU measurement result file Fi1 or Fi4) of the performance test of the hardware prototype in the ECU on the left side of FIG. 14.

On the other hand, the performance test of the simulator in the PC environment is performed on the PC. Here, in the ECU application software Sw1 in the hard disk drive 104 of the PC that implements the simulator, the performance measurement function Sw12 is operated to obtain a measurement result in the simulator in the hard disk drive 104 and the measurement result is stored as the PC measurement result file Fi2.

In the above-described processing in the PC, a start time tsP and an end time teP of the simulation are measured as results (PC measurement result file Fi2) of the performance test of the simulator in the PC (without adjustment) illustrated at the center of FIG. 14. Note that, in FIG. 14, the start times tsE and tsP are displayed as the same time for convenience of explanation. Further, in this state, the timing adjustment based on the delay processing according to the present invention is not executed.

Referring back to FIG. 13, next, the measurement result comparison/delay parameter setting unit Sw21 in the performance comparison software SW2 is operated, and the ECU measurement result file Fi1 and the PC measurement result file Fi2 are compared and verified. As illustrated in FIG. 14, the measurement result comparison/delay parameter setting unit Sw21 calculates an adjustment time based on a difference between the measurement results. In the illustrated example, time differences between the start times tsE and tsP and the end times teE and teP are compared and verified, and a result thereof is stored in the delay parameter file Fi3.

Thereafter, the performance test of the simulator is performed again on the PC by using the stored delay parameter file Fi3. As a result, the PC measurement result file Fi2 is updated.

The measurement result comparison/delay parameter setting unit Sw21 in the performance comparison software SW2 is operated, and the ECU measurement result file Fi1 and the PC measurement result file Fi2 are compared and verified. An adjustment time is recalculated based on a difference between the measurement results, and the delay parameter file Fi3 for implementing an operation closer to that in the actual machine is created.

Although the simulator after the timing adjustment is reflected and stored in the PC measurement result file Fi2 in the example of FIG. 13, it can be stored in an appropriate place. Note that the procedure for the above-described timing adjustment may be automatically performed by the measurement result comparison/delay parameter setting unit Sw21, or a comparison result may be displayed on the display 107 via the comparison result display unit SW22, and a specific content of the timing adjustment may be determined according to the judgment of the developer and reflected.

The right side of FIG. 14 illustrates an example of a start time and an end time in the PC simulator after the timing adjustment. In this example, with respect to the ECU actual measurement time zone (the start time tsE and the end time teE) in the actual environment machine S, the PC sets, as a start time of processing in the PC, a time delayed from the time tsE when a processing command is received by a time of ts0, and when a time of te0 elapses from an end time of the processing in the PC, the PC determines that the end time teE of the ECU actual measurement time zone in the actual environment machine S is reached. That is, by setting the pre-start time of ts0 and the post-end time of te0, the time in the PC simulator is adjusted to be closer to the time in the ECU in the actual environment machine S.

The above-described flow is summarized in FIG. 14 as follows. First, the ECU application software SW1 and SW4 are executed on the PC and the actual ECU, respectively, and a time is recorded at measurement points (the start and end of the function). The measurement timing in the actual ECU is illustrated on the left side of FIG. 14, and the execution timing in the PC simulator is illustrated at the center of FIG. 14. In the performance comparison software SW2 on the PC, the measurement result in the ECU and the measurement result in the PC are compared, a delay amount for covering the performance difference is calculated, and the delay amount is stored in the delay parameter file Fi3.

Next, when the PC simulator is executed, updated delay parameter information is read, delay processing is executed at the start and end of the function, and then the ECU application software SW1 is executed. A processing timing when the delay processing is executed is illustrated on the right side of FIG. 14. It can be seen that the processing timing in the ECU (left side of FIG. 14) is similar to the execution time in the PC simulator.

In Embodiment 6 described above, the execution time and timing measured in the actual ECU are stored in the ECU measurement result file Fi1. Here, the execution time and timing stored in the ECU measurement result file Fi1 can be said to be target data for matching the execution time and the timing stored in the PC measurement result file Fi2. In Embodiment 6, the procedure in which the measurement and comparison are performed on the PC after measuring the target data in the actual environment machine S has been described, but it is a matter of course that it is not necessary to perform the measurement in the actual environment machine S every time in a case where the target data is obtained in advance and stored in the ECU measurement result file Fi1.

Further, in the above-described embodiment, a case where the processing speed in the PC is higher than that in the actual environment machine S, and thus the timing adjustment processing is delay time processing is assumed. However, as described in Embodiment 3 and the like, the present invention can also be applied to a case where the processing speed in the PC is lower than that in the actual environment machine S. In the sense including both cases, it is appropriate that the delay processing is timing adjustment processing. In a broad sense, the present invention is to perform timing adjustment.

Note that the timing adjustment in the present invention does not necessarily intend complete matching with the ECU. For example, in a case where matching of about 90% is possible, it can be said that there is no great disadvantage in simulation.

Further, in the present invention, the actual environment machine S is, for example, the ECU, and the present invention has a characteristic that the ECU has a performance measurement function for measuring the timing when the application software is executed, and holds the ECU measurement result file that stores the measurement result.

### Embodiment 7

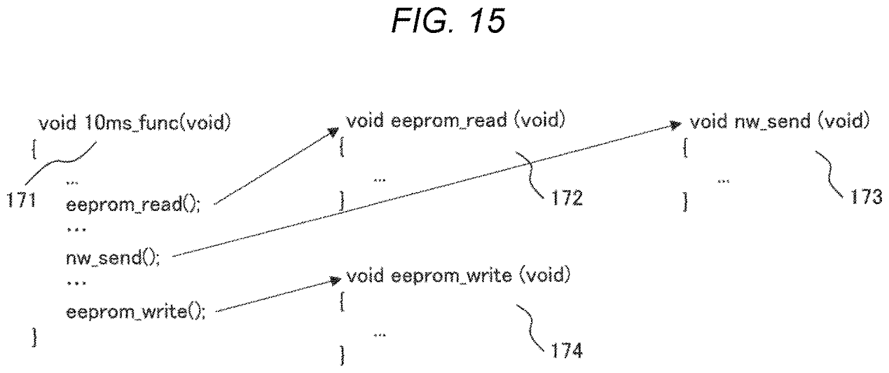

In Embodiment 7, a specific processing example in a case where the timing adjustment function is applied to a single-tasking program will be described with reference to FIGS. 15 to 21.

FIG. 15 is a diagram illustrating an example of the C language program used in the present invention, which is the same as that illustrated in FIG. 5. Although the detailed description of the C language is omitted, the C language program illustrated in FIG. 15 is a simple program in which three sets of func functions that execute a small processing unit, a func1 function 172 (eeprom_read), a func2 function 173 (nw_send), and a func3 function 174 (eeprom_write) are executed in a Main function 171 (10 ms_func) that executes processing in a period of 10 ms. As a result, read processing from eeprom, send processing to nw, and write processing to eeprom are executed within 10 ms which is a control period specified by the Main function 171. Note that the C language program has a function of storing a start time and an end time of the processing.

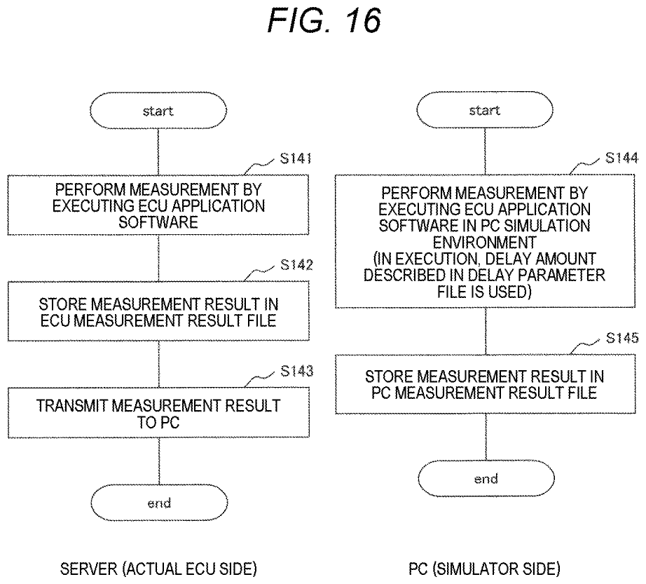

The processing in the PC and the actual environment machine S in the embodiment of the present invention is executed by the above-described C language program. FIG. 16 is a schematic flowchart illustrating contents of processing in the PC and processing in the actual environment machine S, which are executed for delay amount determination and timing adjustment.

The right side of FIG. 16 illustrates the content of the processing in the PC, and the left side of FIG. 16 illustrates the content of the processing in the actual environment machine S.

In a processing flow of FIG. 16, first, execution time measurement is performed in Processing Step S141 in the actual ECU. By executing a performance measurement code described in the program, the execution timing is recorded in Processing Step S142. In Processing Step S143, the execution timing recorded by the actual ECU is transmitted from the measurement result transmitting unit SW42 of the actual ECU to the PC connected to the same network. The PC stores the received measurement result as the ECU measurement result file Fi1.

Next, on the PC, in Process Step S144, the program is executed in the PC simulation environment, and the execution timing is recorded. The execution timing is recorded by executing the performance measurement code described in the program using a setting value of the delay parameter file Fi3 present in the PC. Further, in Processing Step S145, the execution timing recorded in the PC simulation environment is stored in the PC measurement result file Fi2.

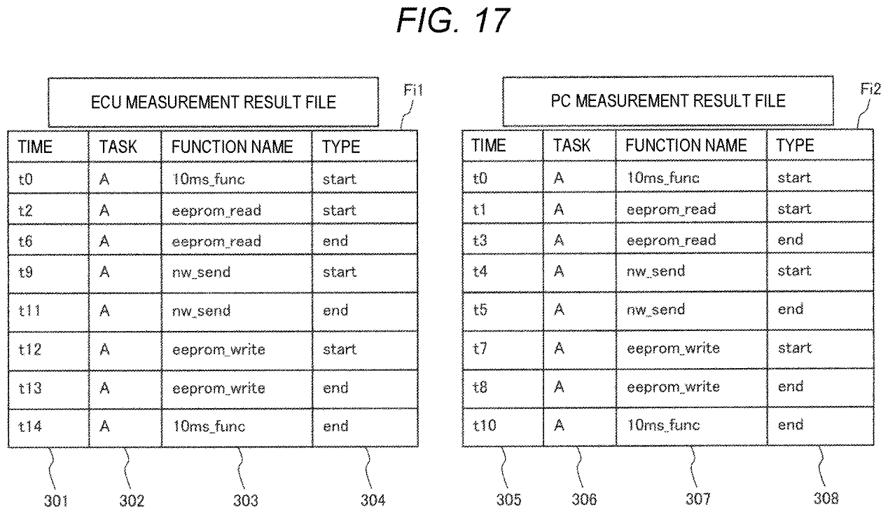

FIG. 17 illustrates an example of configurations of data formed in the ECU measurement result file Fi1 and the PC measurement result file Fi2 created by the above-described processing. These files are created in the same format, and information recorded by the ECU and information recorded by the PC are the same.

As horizontal axis items of the files Fi1 and Fi2 in FIG. 17, four information including a time (301 and 305), an operation task (302 and 306), a function name (303 and 307), and a measurement timing (start/end) (304 and 308) are recorded. An execution time and an operation task are recorded using a time measurement code present at a start part and an end part of a function to be measured by the C language program. In the present embodiment, the single-tasking is described as an example, and since the number of tasks 302 and 306 are one, all of the tasks are the task A.

The ECU measurement result file Fi1 indicates that, for the task A, a start time of the Main function 171 (10 ms_func) is to, a start time of the func1 function 172 (eeprom_read) is t2, an end time of the func1 function 172 (eeprom_read) is t6, a start time of the func2 function 173 (nw_send) is t9, an end time of the func2 function 173 (nw_send) is t11, a start time of the func3 function 174 (eeprom_write) is t12, an end time of the func3 function 174 (eeprom_write) is t13, an end time of the Main function 171 (10 ms_func) is t14, and data is generated in the above order.

Similarly, the PC measurement result file Fi2 indicates that, for the task A, a start time of the Main function 171 (10 ms_func) is t0, a start time of the func1 function 172 (eeprom_read) is t1, an end time of the func1 function 172 (eeprom_read) is t3, a start time of the func2 function 173 (nw_send) is t4, an end time of the func2 function 173 (nw_send) is t5, a start time of the func3 function 174 (eeprom_write) is t7, an end time of the func3 function 174 (eeprom_write) is t8, an end time of the Main function 171 (10 ms_func) is t10, and data is generated in the above order.

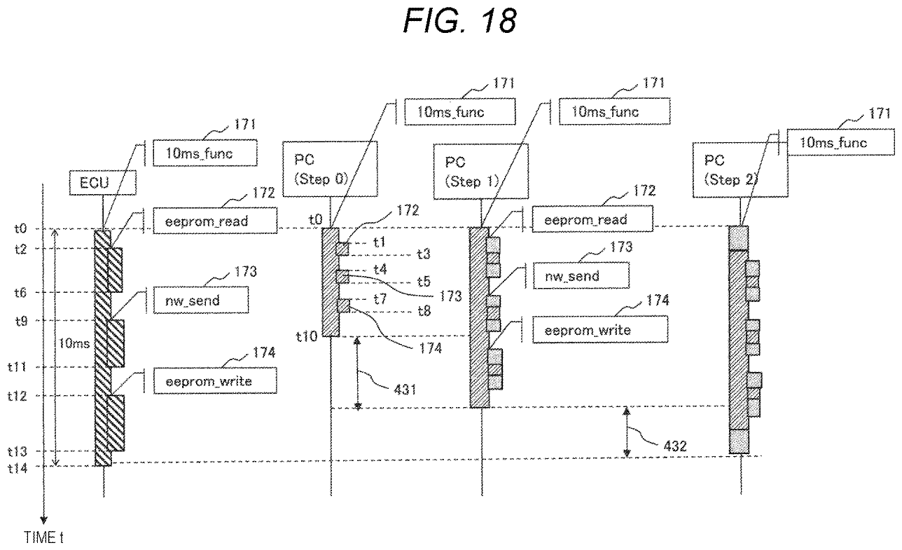

FIG. 18 is a diagram illustrating a time relationship before and after timing adjustment. Two columns on the left side of FIG. 18 show a situation when the time relationship of FIG. 17 is measured. As for the ECU, the child functions 172, 173, and 174 are sequentially executed within 10 ms specified by the parent function 171, and each start time and each end time are indicated on a left vertical axis. As for the PC, the child functions 172, 173, and 174 are sequentially executed in the parent function 171, but as can be seen from each start time and each end time, in a case when the PC has a higher performance and a higher speed than those of the actual environment machine S, a series of processing of the child functions are completed before 10 ms specified by the parent function 171 elapses.

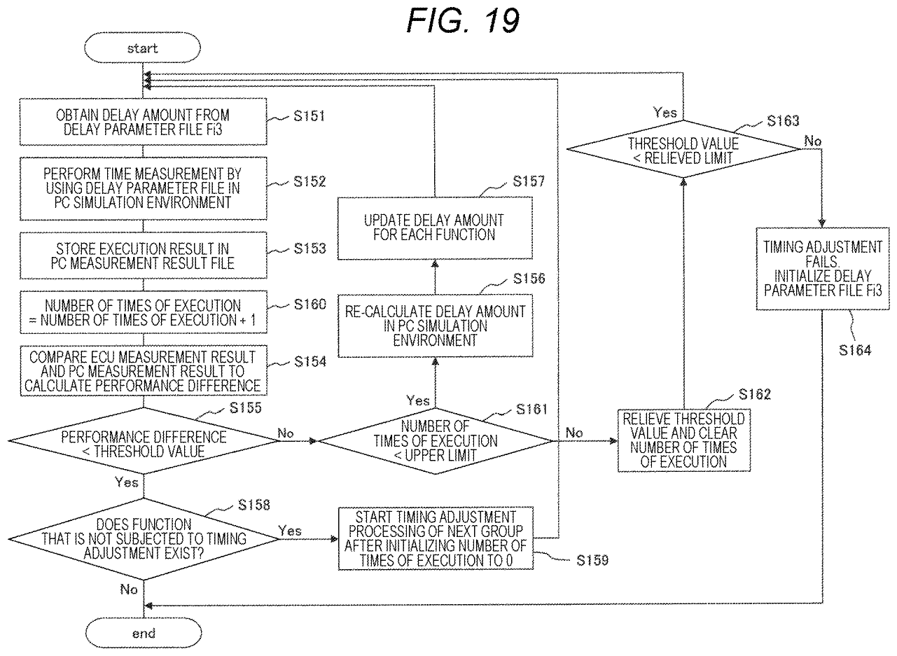

After measurement results of the ECU and the PC are obtained, the performance comparison software SW2 is used to compare the measurement results, a delay amount to be injected in the PC simulation environment is determined, and the delay parameter file Fi3 is updated. FIG. 19 illustrates a specific processing flow of the update of the delay parameter file Fi3, which is processing executed here.

A delay amount is obtained from the delay parameter file Fi3 in Processing Step S151 which is the first processing in the processing flow of FIG. 19, time measurement using the delay parameter file Fi3 is performed in the PC simulation environment in Processing Step S152, and an execution result is stored in the PC measurement result file Fi2 in Processing Step S153. The processing flow here is as illustrated in FIG. 16. Since the series of processing are repeatedly executed multiple times while changing a delay parameter, the number of times of repetition is counted while updating the number of times of execution in Processing Step S160.

In Processing Step S154, the ECU measurement result and the PC measurement result are compared to calculate a performance difference, and a specific processing content thereof will be described. In this case, there are multiple functions (Main function and a plurality of Func functions) by the C language program, whose execution times are to be compared, and there is a calling relationship between the respective functions. Therefore, the functions are executed from performance comparison and a group with small pieces of processing (functions that are not called by others).

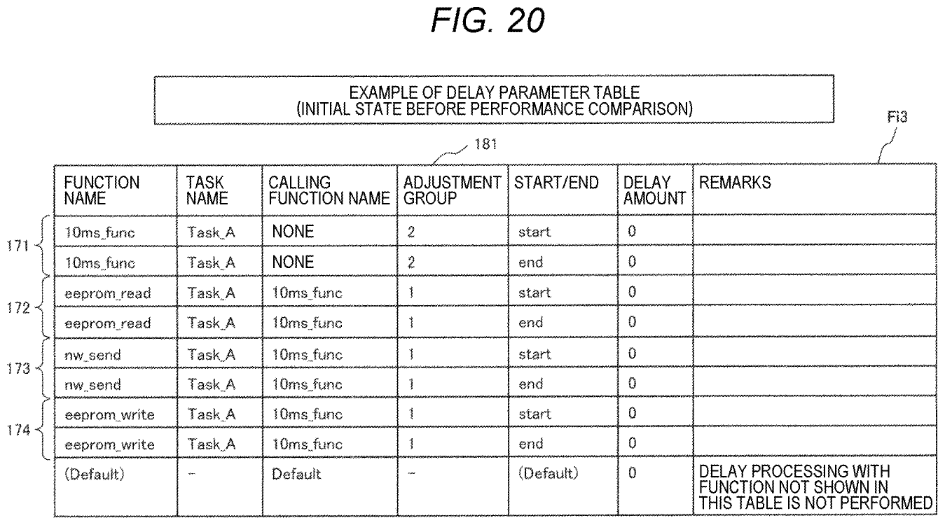

FIG. 20 illustrates an example of a delay parameter table in an initial state before the performance comparison. In FIG. 20, horizontal axis items include a function name, a task name, a calling function name, an adjustment group 181, start/end, a delay amount, and remarks. In the example of FIG. 15, as the function names, each of the Main function 171 which is a parent function, and the func functions 172, 173, and 174 which are child functions is described in rows corresponding to the start and the end, respectively. The calling function name describes the parent function when viewed from the child functions, and since it is the initial state before the performance comparison, the column of the delay amount is set to 0. In this table, the adjustment group 181 is set for each parent-child relationship, an adjustment group “2” is set for the parent function, and an adjustment group “1” is set for the child functions.

The adjustment in Processing Step S154 is performed in order from the smallest adjustment group 181 described in the delay parameter table of FIG. 20. In the present embodiment, as the smallest function, the (eeprom_read), (nw_send), and (eeprom_write) functions, which are the func functions 172, 173, and 174 ranked as the adjustment group “1”, are selected first, and executed in this order.

Describing the time relationship illustrated in FIGS. 17 and 18, execution times of the (eeprom_read), (nw_send), and (eeprom_write) functions from the start to the end in the actual ECU are (t6−t2), (t11−t9), and (t13−t12), respectively, and execution times in the PC simulation environment are (t3−t1), (t5−t4), and (t8−t7), respectively.

In Processing Step S155 of the processing flow of FIG. 19, first, for the child function (eeprom_read), it is determined whether or not a difference in execution time between the actual ECU and the PC simulation environment is larger than a threshold value. In a case where the difference is larger than the threshold value, the processing flow proceeds to Processing Step S156, and delay amount calculation processing for executing delay processing for a designated time in the PC simulation environment is executed. In a case of the child function (eeprom_read), a difference in execution time is calculated as ((t6−t2)−(t3−t1)).

In Processing Step S157, the delay amount is updated for each function. First, the delay amount is updated for the child function (eeprom_read). Here, that delay processing is executed in the PC simulation environment by the difference in execution time, which makes it possible to adjust the processing time in the PC simulation environment to be closer to the processing time in the actual ECU. Since the delay amount adjustment is performed at two points, that is, when the function starts and when the function ends, an amount obtained by dividing the difference in execution time into two is written as the delay amount in the delay parameter file Fi3.

Note that the differences in the execution time of the (nw_send) and (eeprom_write) functions obtained by the subsequent repetitive processing are ((t11−t9)−(t5−t4)) and ((t13−t12)−(t8−t7)), respectively.

Also for these, Processing Step S156 and Processing Step S157 are sequentially performed, and the delay amount for each child function is determined.

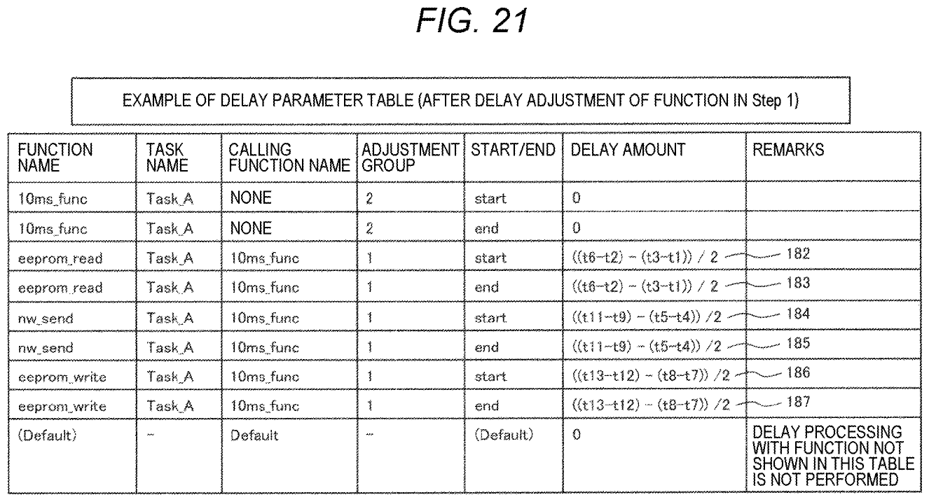

FIG. 21 illustrates a delay parameter table in a first step (Step 1) in which the delay amount for each child function is reflected in the delay parameter table in the initial state of FIG. 20. Therefore, update data of the delay amounts of the (eeprom_read), (nw_send), and (eeprom_write) functions which are child functions are reflected here. The delay amounts calculated above are written at six points 182 to 187.

Note that examples of the delay processing include processing of performing a wasteful operation is performed for the delay time or processing of unnecessarily executing a while loop, instead of putting the task to sleep.

Next, in Processing Step S158 of FIG. 19, when the adjustment of the (eeprom_read), (nw_send), and (eeprom_write) functions which are child functions is completed, it is determined whether or not a function that is not subjected to timing adjustment exists.

A time relationship of processing in the simulator at a state where child function adjustment ends is illustrated as an example in “Step 1” which is the second from the right in FIG. 18. As for the relationship with the ECU, the time relationships of the child functions almost match those in the ECU. At the stage where the child function adjustment ends, as a whole, matching with the execution time in the ECU is realized only by a time length indicated by 431, and time matching of a portion corresponding to a time length 432 is still not realized.

In a second step (Step 2), execution timing adjustment is performed for the function (10 ms_func) which is the function (the parent function calling the child functions described above) described in the adjustment group “2” described in the delay parameter table in FIG. 20. The timing adjustment processing for the parent function starts after confirming the completion of all child functions in Processing Step S158 of FIG. 19 and initializing the number of times of execution to 0 in Processing Step S159. The timing adjustment processing for the parent function is made by sequentially and repeatedly performing Processing Steps S151, S152, S153, S160, S154, S155, S161, S156, and S157 as many times as necessary, similar to a case of the child functions.

An execution timing when the processing from Processing Step S151 in FIG. 19 is executed again and the performance difference with the actual ECU is measured again is described as “Step 2” on the right side of FIG. 18, and is an execution timing in which time matching of a portion corresponding to the time length 432 is realized. This execution timing is obtained by delaying an execution start timing of the parent function by the half of the time length 432.

Therefore, in the PC environment, a timing after a time corresponding to the half of the time length 432 elapses from an execution end timing of the parent function should match an end timing in the ECU environment.

According to the series of processing in FIG. 19, the delay processing is first executed for the child function, and then the delay processing is executed for the parent function to end the processing. Here, the determination of the end of the processing is completed by confirming that a function that is not subjected to timing adjustment does not exist in Processing Step S158.

Note that, in the series of processing, it is preferable to additionally perform the following processing. First, in Processing Step S161, the number of times of repetition of the delay processing of the function is within a predetermined upper limit (in the example of FIG. 20, 8 obtained by 4 (the number of functions)*2 (start/end)), and the delay processing is not repeated more than the upper limit.

It is also preferable to assume a case where the delay amount adjustment processing using the performance comparison software SW2 does not end. A performance adjustment flow at this time will be described with reference to FIG. 19. For example, an operation of one function may change due to a change in execution timing of another function. A case where erroneous processing is switched to normal processing or the like can be an example.

In FIG. 19, in a case where the performance difference is not less than the threshold value in the determination condition of Processing Step S155 and the determination condition of Processing Step S161 is Yes (the number of times of execution exceeds the upper limit), the threshold value is changed. In Process Step S162 of FIG. 19, delay amount adjustment is performed with a relieved allowable performance difference. In a case where re-adjustment is performed, the number of times of execution reaches the upper limit, and the performance difference is not less than the threshold value (in a case where the result of Processing Step S163, which is the determination condition, is No), it is determined that timing adjustment cannot be performed, and in Process Step S164 of FIG. 19, the content of the delay parameter file Fi3 is initialized (no delay injection), and the performance adjustment processing ends.

With the above, the delay amount adjustment processing for one PC in the PC simulation environment ends. Generally, the type (HW specification) of PC used by each developer is different, but the execution timing in the PC simulation environment for each developer can be adjusted to be closer to that in the actual ECU by performing the delay amount adjustment for each PC.

### Embodiment 8

Although Embodiment 7 has described a case where the delay amount determination and the timing adjustment are performed in the single-tasking environment, the ECU application software is often operated in the multitasking environment.

In the multitasking environment, context switching occurs based on task priority. An end time of a function changes depending on whether or not the context switching occurs.

In Embodiment 8, at the time of calculation of an execution time of a function in the performance comparison software Sw2, even when the context switching occurs, an actual processing time can be calculated by considering operation task information.

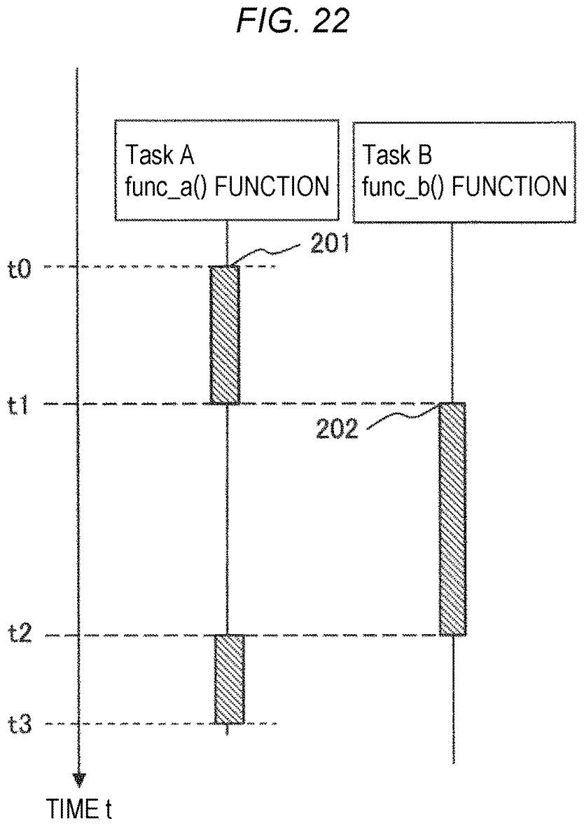

Information on two tasks used in the present embodiment is illustrated in FIG. 22 and will be described.

FIG. 22 illustrates an example of a content of a measurement result file and an execution timing of each task when context switching of tasks occurs.

In this example, there are tasks A and B, and both A and B are tasks that are activated by a timer event and execute processing periodically. However, the task B has a higher priority, and the task B with a higher priority is activated during the execution of the task A.

In time series, the task A starts processing triggered by a timer event 201 from a time t0. When a timer event 202 of the task B is issued at a time t1 during the execution of the processing of the task A, the execution of the task A is interrupted and the processing of the task B starts in accordance with the priority. Then, the processing of the task B ends at a time t2, the processing of the task A is resumed, and finally the task A ends at a time t3.

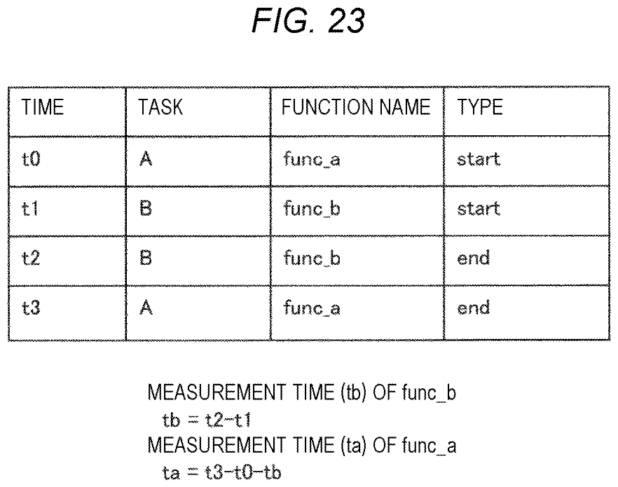

Here, a start time and an end time stored for adjusting a timing are managed for each task, and each task stores the start time and the end time. FIG. 23 illustrates an example of a start time and an end time stored in each task. In a case of multitasking, an actual execution time is calculated by subtracting a time during which another task is operated from an execution time of a function.

For example, an execution time of the task A interrupted by the task B can be calculated by ((t3−t0)−(t2−t1)), in which a start time and an end time of a function (func_a) of the task A are t0 and t3, respectively, and a start time and an end time of a function (func_b) of the task B are t1 and t2, respectively.

In the present invention described above, the ECU software has a time measurement function and a delay injection function. The software is executed in the actual ECU and the PC simulation environment, and an execution timing (an elapsed time after activation) is recorded.

Performance comparison software having a function of comparing contents of processing timing data that store execution timings in the actual ECU and the PC simulator, determining the amount of delay injected in the PC simulator based on a difference in processing time, and storing the determined delay amount in a file is prepared.

Using information in a delay parameter file updated by executing the performance comparison software, the ECU application software is executed again in the PC simulation environment. By executing delay processing with an adjusted delay amount in the PC simulation environment, the execution timing in the PC simulation environment can be adjusted to be closer to that in the actual ECU.

In time measurement, recording is performed at the start and end of a function whose execution timing is to be adjusted. Further, the delay processing is executed immediately after the time measurement at the start of the function and immediately before the time measurement immediately before the end of the function. It is possible to execute the delay processing at any one of those or both of those.

When the HW prototype of the ECU is not prepared, a CPU evaluation board or ECU hardware that is the basis of the development can be used, an execution timing therein can be stored as information on an execution timing in the ECU, and the information can be used as an execution timing in the actual ECU.

### REFERENCE SIGNS LIST

101 system bus
102 CPU
103 main storage device
104 HDD
105 keyboard
106 mouse
107 display
108 ROM
S actual environment machine
PC (PCa, PCb, . . . , PCn) personal computer
180 communication device
181 external system bus
Sw1 ECU application software
Sw2 performance comparison software
Sw3 communication software
SW11 delay injection function
SW12 performance measurement function
SW21 measurement result comparison/delay parameter setting unit
SW22 comparison result display unit
SW31 measurement result receiving unit
Fi1 ECU measurement result file
Fi2 PC measurement result
Fi3 delay parameter file
SW4 ECU application software
SW41 performance measurement function
SW42 measurement result transmitting unit
Fi4 ECU measurement result file

1. A simulation device comprising:
a first computer including a first performance measurement function that obtains a first processing timing when the first computer executes application software, and a timing adjustment function that performs timing adjustment of an execution time of the application software in the first computer based on a time difference between the first processing timing and a second processing timing when a second computer executes the application software.

2. The simulation device according to claim 1, wherein the first computer is connected to the second computer via a communication device, and the second computer includes a second performance measurement function that obtains the second processing timing when the second computer executes the application software.

3. The simulation device according to claim 1, wherein
the second computer including a second performance measurement function that obtains, as the second processing timing, a processing timing when the application software is executed; and
the simulation device further comprising a communication device via which the first computer and the second computer are connected to each other.

4. The simulation device according to claim 1, wherein the timing adjustment function adjusts the first processing timing to match the second processing timing as a target timing.

5. The simulation device according to claim 1, wherein the application software is described in a language in which a child function is executed in a parent function and a function start time and a function end time of each of the parent function and the child function are recorded.

6. The simulation device according to claim 5, wherein in the timing adjustment of the execution time of the application software in the first computer, timing adjustment of the parent function is performed after timing adjustment of the child function is completed.

7. The simulation device according to claim 1, wherein the second computer is an electronic control unit (ECU).

8. The simulation device according to claim 1, wherein a plurality of the first computers are connected via the communication device.

9. An ECU device comprising:
a performance measurement function for obtaining a second processing timing when application software is executed;
a measurement result storing unit that stores the second processing timing; and
a communication device for transmitting the second processing timing to the outside.

10. A simulation method comprising:
performing timing adjustment of an execution time of application software in a first computer based on a time difference between a first processing timing when the first computer executes the application software and a second processing timing when a second computer executes the application software.
